(19) United States
(12) Patent Application Publication
(10) Pub. No.: US 2010/0214965 A1
(43) Pub. Date: Aug. 26, 2010

(54) APPARATUS AND METHOD FOR SUPPORTING PARTIAL FREQUENCY DIVISION DUPLEX IN A COGNITIVE RADIO WIRELESS COMMUNICATION SYSTEM

(75) Inventors: Ho-Dong KIM, Gwacheon-si (KR); Eun-Taek LIM, Suwon-si (KR); Sang-Bum KIM, Seoul (KR); Ju-Yeon SONG, Seoul (KR); Jung-Soo WOO, Suwon-si (KR); Cheng SHAN, Suwon-si (KR); Yong-Ho PARK, Cheonan-si (KR); Jae-Ik PARK, Seoul (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/700,918

(22) Filed: Feb. 5, 2010

(30) Foreign Application Priority Data
Feb. 20, 2009 (KR) 10-2009-0014174

(51) Int. Cl. H04J 3/00

(52) U.S. Cl. 370/280

(57) ABSTRACT

An operating method and apparatus of a Customer Premise Equipment (CPE) in a Cognitive Radio (CR) wireless communication system and a base station in the CR wireless communications system are provided. The method includes, when receiving a beacon message from a Primary User (PU), transmitting a mode change request message including a signal strength from the PU and a channel number interfering with the PU to a base station, when receiving a mode change reply message from the base station, determining whether a partial Frequency Division Duplex (FDD) scheme is applied, and, when the partial FDD scheme is applied, communicating by receiving a downlink burst in a Time Division Duplex (TDD) channel indicated by the mode change reply message and transmitting an uplink burst in an FDD channel indicated by the mode change reply message.

### PRIORITY

This application claims the benefit under 35 U.S.C. §119(a) of a Korean patent application filed in the Korean Intellectual Property Office on Feb. 20, 2009 and assigned Serial No. 10-2009-0014174, the entire disclosure of which is hereby incorporated by reference.

### BACKGROUND OF THE INVENTION

1. Field of the Invention

The present invention relates to a Cognitive Radio (CR) wireless communication system. More particularly, the present invention relates to an apparatus and a method for supporting partial Frequency Division Duplex (FDD) in the CR wireless communication system.

2. Description of the Related Art

Recently, coexistence of numerous wireless communication techniques results in a gradual decrease of available frequency resources. To address the decrease of available frequency resources, research is performed on a Cognitive Radio (CR) technique which senses and uses a frequency band or a channel currently out of use among particular frequency bands pre-allocated.

A CR network includes a CR base station, a Customer Premise Equipment (CPE), a Primary User (PU), and a Secondary User (SU). The CR base station is in charge of connection, management and control of the CPE. The CPE interconnects the CR base station and the SU. The PU, which is also called an Incumbent User (IU), is a user of a system using Ultra High Frequency (UHF)/Very High Frequency (VHF) band, for example, a TeleVision (TV) or a wireless microphone using a TV broadcast band. The PU has a frequency license and needs to be protected against channel interference of the SU. The SU has no frequency license similar to the TV band but utilizes the frequency band not used by the PU. When using the same frequency band as the PU, the SU has to use another unused frequency band other than a corresponding frequency band.

When the CR system operates, a PU appears to each base station. When the PU uses the channel managed by a current CR base station, the CR base station cannot use the channel as a downlink channel. More particularly, as a number of available channels decreases, the CR base station is limited in the channel use and system performance is degraded.

Therefore, a need exists for maintaining system performance of a CR wireless communication system with a small number of channels.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for increasing channel usage efficiency in a Cognitive Radio (CR) wireless communication system.

Another aspect of the present invention is to provide an apparatus and a method for supporting a partial Frequency Division Duplex (FDD) scheme integrating a Time Division Duplex (TDD) scheme and an FDD scheme in a CR wireless communication system.

Yet another aspect of the present invention is to provide an apparatus and a method for identifying a Customer Premise Equipment (CPE) which interferes with a Primary User (PU) in a CR wireless communication system.

In accordance with an aspect of the present invention, an operating method of a CPE in a CR wireless communication system is provided. The method includes, when receiving a beacon message from a PU, transmitting a mode change request message including a signal strength from the PU and a channel number interfering with the PU to a base station, when receiving a mode change reply message from the base station, determining whether a partial FDD scheme is applied, and, when the partial FDD scheme is applied, communicating by receiving a downlink burst in a TDD channel indicated by the mode change reply message and transmitting an uplink burst in an FDD channel indicated by the mode change reply message.

In accordance with another aspect of the present invention, an operating method of a base station in a CR wireless communication system is provided. The method includes, when receiving a mode change request message from a CPE, determining whether to apply a partial FDD scheme to the CPE, transmitting a mode change reply message comprising whether the partial FDD scheme is applied to the CPE, and, when applying the partial FDD scheme to the CPE, communicating with the CPE by transmitting a downlink burst in a TDD channel indicated by the mode change reply message and receiving an uplink burst in an FDD channel indicated by the mode change reply message.

In accordance with yet another aspect of the present invention, an apparatus of a CPE in a CR wireless communication system is provided. The apparatus includes a transmitter for, when receiving a beacon message from a PU, transmitting a mode change request message including a signal strength from the PU and a channel number interfering with the PU to a base station, an analyzer for, when receiving a mode change reply message from the base station, determining whether a partial FDD scheme is applied, and a controller for, when the partial FDD scheme is applied, communicating by receiving a downlink burst in a TDD channel indicated by the mode change reply message and for transmitting an uplink burst in an FDD channel indicated by the mode change reply message.

In accordance with still another aspect of the present invention, an apparatus of a base station in a CR wireless communication system is provided. The apparatus includes a controller for, when receiving a mode change request message from a CPE, determining whether to apply a partial FDD scheme to the CPE, and a transmitter for transmitting a mode change reply message comprising whether the partial FDD scheme is applied to the CPE. When the partial FDD scheme is applied to the CPE, the controller communicates with the CPE by transmitting a downlink burst in a TDD channel indicated by the mode change reply message and receiving an uplink burst in an FDD channel indicated by the mode change reply message.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments the present invention will be more apparent from the following description taken in conjunction with the accompanying drawings, in which:

FIG. 1 illustrates transmission and reception in a Time Division Duplex (TDD) scheme and a Frequency Division Duplex (FDD) scheme according to an exemplary embodiment of the present invention;

FIGS. 2A, 2B and 2C illustrate channel use in a Cognitive Radio (CR) wireless communication system according to an exemplary embodiment of the present invention;

FIGS. 3A and 3B illustrate a frame structure when a partial FDD scheme is applied in a CR wireless communication system according to an exemplary embodiment of the present invention;

FIG. 4 illustrates operations of a Customer Premise Equipment (CPE) in a CR wireless communication system according to an exemplary embodiment of the present invention;

FIG. 5 illustrates operations of a CR base station in a CR wireless communication system according to an exemplary embodiment of the present invention;

FIG. 6 illustrates a CPE in a CR wireless communication system according to an exemplary embodiment of the present invention; and

FIG. 7 illustrates a CR base station in a CR wireless communication system according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide a technique for increasing channel use efficiency in a Cognitive Radio (CR) wireless communication system. Hereinafter, an Orthogonal Frequency Division Multiplexing (OFDM)/Orthogonal Frequency Division Multiplex Access (OFDMA) wireless communication system is described by way of example. However, other wireless communication systems may also be applied.

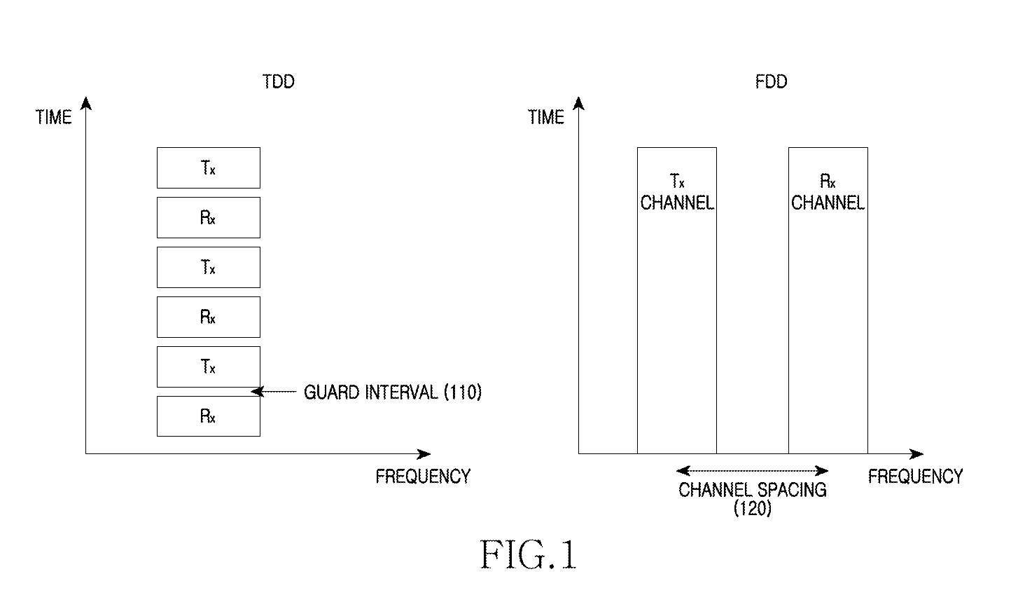

FIG. 1 illustrates transmission and reception in a Time Division Duplex (TDD) scheme and a Frequency Division Duplex (FDD) scheme according to an exemplary embodiment of the present invention.

A duplex scheme for bidirectional communications is divided largely into a Time Division Duplex (TDD) scheme and a Frequency Division Duplex (FDD) scheme. The TDD scheme and the FDD scheme are compared in FIG. 1.

Referring to FIG. 1, the TDD scheme divides a channel of the same frequency band to a Transmit (Tx) interval and a Receive (Rx) interval in a time axis. To block influence between the Tx interval and the Rx interval, a guard interval 110 is inserted. The FDD scheme divides two or more frequency channels to a Tx channel and an Rx channel. To block influence between the Tx channel and the Rx channel, a channel spacing 120 is inserted.

To efficiently utilize a limited number of channels, the CR wireless communication system operates based on the TDD scheme and partially applies the FDD scheme. The CR wireless communication system supporting the partial FDD scheme is described below.

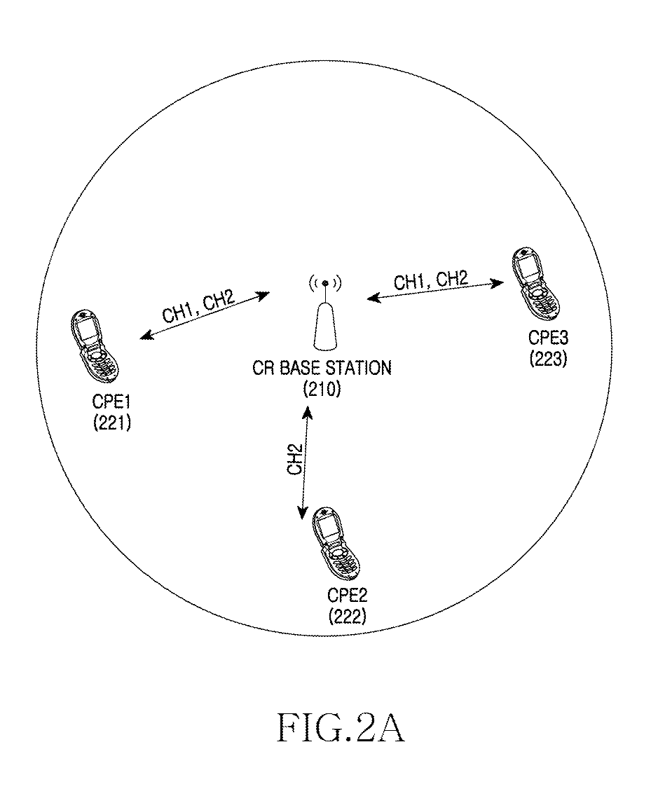

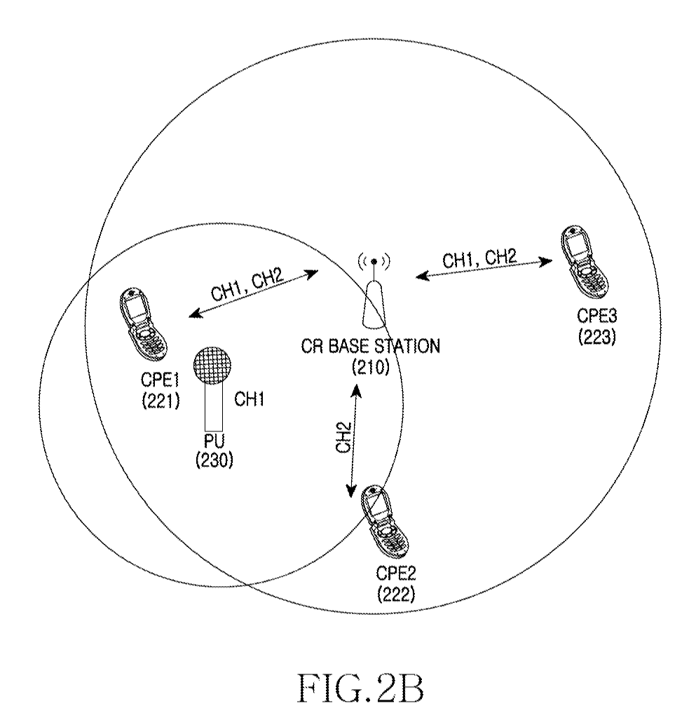

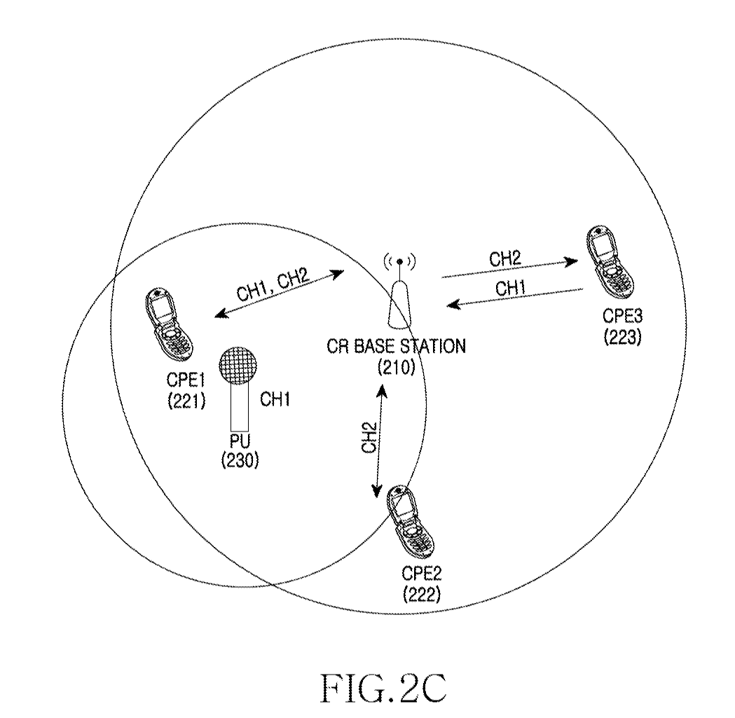

FIGS. 2A, 2B and 2C illustrate channel use in a CR wireless communication system according to an exemplary embodiment of the present invention.

Referring to FIG. 2A, a CR base station 210 is using two channels, such as CH1 and CH2. A Customer Premise Equipment (CPE)1 221 uses CH1 and CH2, CPE2 222 uses CH2, and CPE3 223 uses CH1 and CH2. The CR base station 210 and the CPEs 221, 222 and 223 conform to a scalable OFDMA scheme. That is, the CR base station 210, CPE1 221, and CPE3 223, which simultaneously use CH1 and CH2, utilize as a single channel by increasing a Fast Fourier Transform (FFT) size, without separately using channels. FIG. 2A illustrates a case where a Primary User (PU) 230 does not use a channel. Accordingly, the CR base station 210 and the CPEs 221, 222 and 223 communicate over CH1 and CH2 without any limitation.

Referring to FIG. 2B, when the PU 230 uses CH1 in a cell of the CR base station 210, the CR base station 210 cannot use CH1. That is, to prevent interference to the PU 230, the CR base station 210 and the CPEs 221, 222 and 223 cannot use CH1 as a downlink channel. When CH1 is used as the downlink channel, channel interference is exerted directly on the PU 230 in the cell of the CR base station 210. As a result, CPE1 221 and CPE3 223, which were using CH1, may not perform downlink communication over CH1 anymore. In addition, since the PU 230 is adjacent to CPE1 221, CPE1 221 cannot use CH1 as an uplink channel. CPE2 222 using CH2 communicates regardless of an appearance of the PU 230.

Referring to FIG. 2C, the CR base station 210, which recognizes the operations of FIG. 2B, applies the partial FDD. Due to the appearance of the PU 230 using CH1, the CR base station 210 cannot use CH1 as the downlink channel. However, since CPE3 223 is far away from the PU 230, that is, since CPE3 223 lies outside the interference range, it may use CH1 as the uplink channel. Hence, CPE1 221 uses CH2 as the uplink channel and the downlink channel, and CPE3 223 uses the downlink interval of CH2 as the downlink channel and uses CH1 as the uplink channel as illustrated in FIG. 2C. In other words, CPE1 221 uses CH2 according to the TDD scheme, and CPE3 223 uses CH1 and CH2 according to the partial FDD scheme.

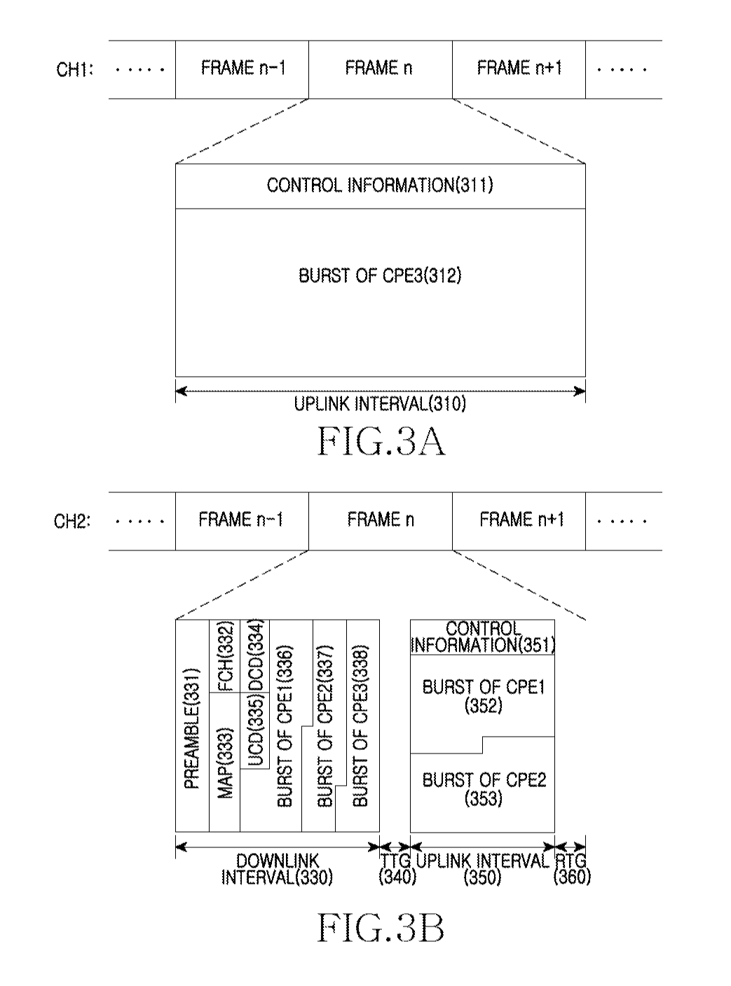

When the partial FDD is adopted as illustrated in FIG. 2C, frame usage of the CR base station 210 and the CPEs 221, 222 and 223 is illustrated in FIG. 3.

FIGS. 3A and 3B illustrate a frame structure when a partial FDD scheme is applied in a CR wireless communication system according to an exemplary embodiment of the present invention.

In FIGS. 3A and 3B, CH1 is used as an uplink channel of CPE3 223 conforming to a FDD scheme. CH2 is the uplink channel and a downlink channel of CPE1 221 and CPE2 222 conforming to a TDD scheme and used as the uplink channel of CPE3 223 conforming to the FDD scheme.

Referring to FIG. 3A, a frame of CH1 includes an uplink interval 310. The uplink interval 310 includes control information 311 and a burst 312 of CPE3 223. The control information 311 is information for ranging, bandwidth request, Urgent Coexistence Situation (UCS) notification, and the like. The ranging indicates a physical signal for time offset adjustment and power adjustment, the bandwidth request requests an uplink resource of a CPE, and the UCS notification indicates that the CPE notifies detection of the PU. The remaining region of the uplink interval 310 is used to transmit the uplink burst 312 of CPE3 223.

Referring to FIG. 3B, the frame of CH2 includes a downlink interval 330, a Tx Transition Gap (TTG) 340, an uplink interval 350, and an Rx Transition Gap (RTG) 360. The downlink interval 330 includes a preamble 331, a Frame Control Header (FCH) 332, a MAP 333, a Downlink Channel Descriptor (DCD) 334, an Uplink Channel Descriptor (UCD) 335, a burst 336 of CPE1 221, a burst 337 of CPE2 222, and a burst 338 of CPE3 223. The uplink interval 350 includes control information 351, a burst 352 of CPE1 221, and a burst 353 of CPE2 222. The preamble 331 is a signal for frame synchronization acquisition and channel estimation. The FCH 332 is decoding information of the MAP 333, the MAP 333 is allocation information of the bursts, and the DCD 334 and the UCD 335 are messages describing physical layer characteristics of the channels of the downlink and the uplink. The remaining region of the downlink interval 330 is used to transmit the burst 336 of CPE1 221, the burst 337 of CPE2 222, and the burst 338 of CPE3. 223. The control information 351 is the same as the control information 311 of CH1. The remaining region of the uplink interval 350 is used to transmit the burst 352 of CPE1 221 and the burst 353 of CPE2 222.

Operations and structures of the CR base station and the CPE employing the partial FDD scheme are described above.

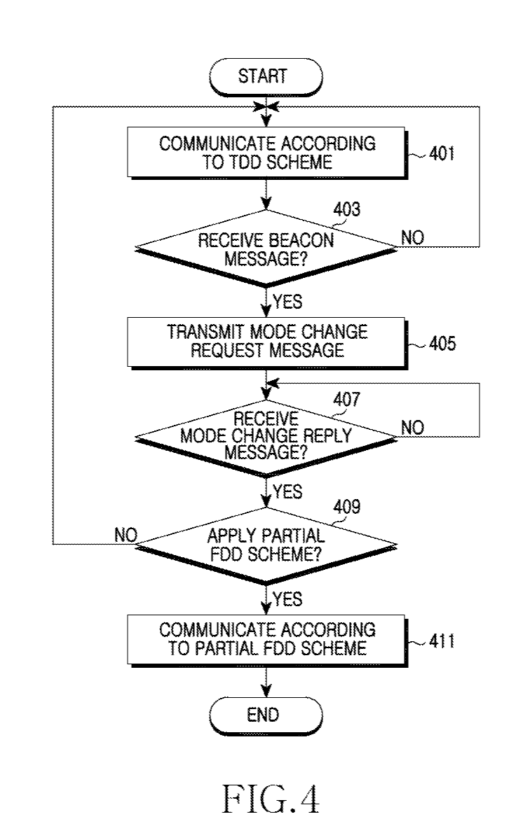

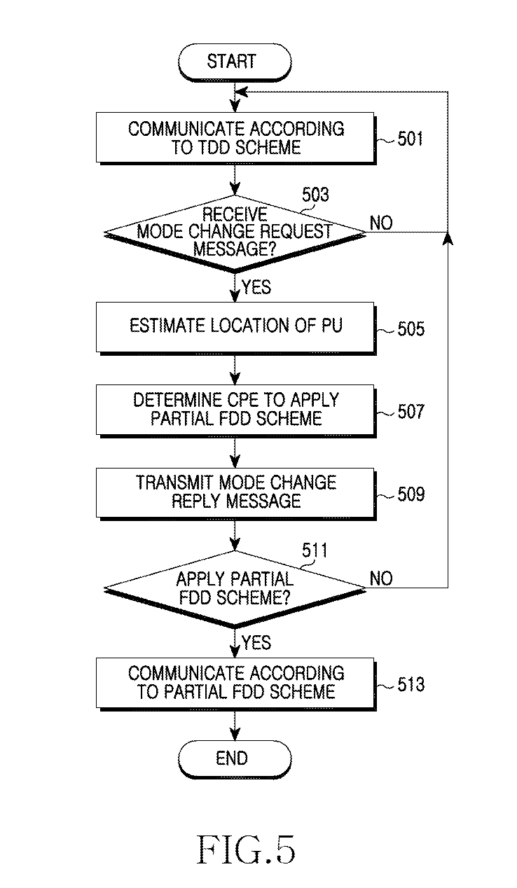

FIG. 4 illustrates operations of a CPE in a CR wireless communication system according to an exemplary embodiment of the present invention.

Referring to FIG. 4, the CPE communicates according to a TDD scheme in step 401. That is, the CPE is assigned at least one channel as its operating channel from the CR base station, and transmits and receives the burst using the allocated resource in the operating channel.

In step 403, the CPE determines whether a beacon message is received from the PU. In more detail, the CPE communicates with the CR base station and concurrently monitors whether the beacon message is received. For example, the beacon message includes an IDentifier (ID) of the PU interfered by the CPE or the CR base station, and a channel number. Herein, the beacon message is transmitted over a predefined beacon channel in a frame defined for communication between the CPE and the CR base station. Thus, the CPE receives the beacon message over the beacon channel without separate resource allocation information.

Upon receiving the beacon message, the CPE transmits a mode change request message to the CR base station in step 405. Herein, the mode change request message includes signal strength information from the PU so that the CR base station may estimate a location of the PU which transmits the beacon message. For example, the mode change request message is constituted as shown in Table 1.

TABLE 1

| Syntax | Note |
|---|---|
| CPE ID | ID of CPE which transmits the mode change |
| | request message |
| Primary User ID | ID of PU interfered |
| Channel Number | Channel number of PU interfered |
| Signal Strength | Signal strength from PU, which is measured |
| | at the CPE |

In step 407, the CPE determines whether a mode change reply message is received. That is, the CPE verifies whether a result of the mode change request is notified. The mode change reply message indicates whether a partial FDD scheme is used, the channel number in compliance with a TDD scheme, and the channel number in compliance with a FDD scheme.

When receiving the mode change reply message, the CPE verifies whether the partial FDD scheme is applied to itself in step 409. When the partial FDD scheme is not applied, the CPE returns to step 401. When the partial FDD is not applied, usage of some operating channel may be suspended.

By contrast, when the partial FDD scheme is applied, the CPE communicates in conformity with the partial FDD scheme in step 411. The CPE receives a downlink burst in a TDD channel and transmits the uplink burst in the FDD channel.

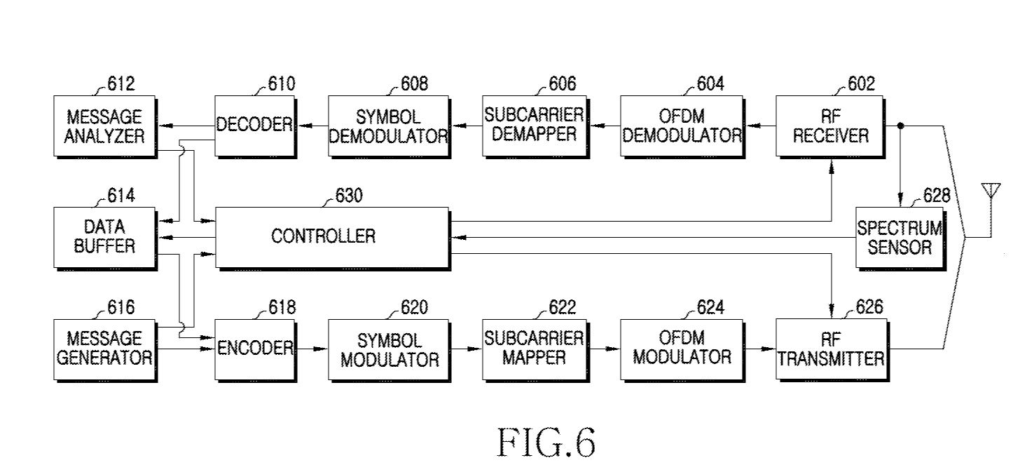

FIG. 5 illustrates operations of a CR base station in a CR wireless communication system according to an exemplary embodiment of the present invention.

Referring to FIG. 5, the CR base station communicates according to a TDD scheme in step 501. The CR base station designates at least one channel as its operating channel, and transmits and receives a burst by dividing an operating channel into a downlink interval and an uplink interval.

In step 503, the CR base station determines whether a mode change request message is received. That is, the CR base station verifies whether an appearance of a PU is notified from at least one CPE. Herein, the mode change request message includes signal strength information from the PU so that the CR base station may estimate a location of the PU which transmits a beacon message. For example, the mode change request message is constituted as shown in Table 1.

When receiving the mode change request message, the CR base station estimates the location of the PU which transmits the beacon message in step 505. In more detail, the CR base station aggregates the signal strength information contained in at least one mode change request message and estimates the location of the PU using the aggregated signal strength information. For example, the CR base station may estimate the location of the PU through triangulation. Since the CPEs in a cell are not mobile, the CR base station is aware of the locations of the CPEs.

In step 507, the CR base station determines the CPE to apply a partial FDD scheme. Hence, the CR base station determines to apply the partial FDD scheme to at least one of the CPEs transmitting the mode change request message, or determines not to apply the partial FDD scheme to any CPE. When determining to apply the partial FDD scheme, the TDD channel and the FDD channel of the corresponding CPE are designated. In other words, among operating channels of the CPE, a channel interfering with the PU is designated as an uplink channel of the CPE and other channels are designated as a downlink channel.

In step 509, the CR base station transmits the mode change reply message to the CPE which transmits the mode change request message. Herein, the mode change reply message indicates whether the partial FDD scheme is adopted, the channel number in compliance with the TDD scheme, and the channel number in compliance with the FDD scheme. For example, the mode change reply message is constituted as shown in Table 2.

TABLE 2

| Syntax | | Note |
|---|---|---|
| CR BS ID | | ID of the CR base station which |
| | | transmits the mode change reply |
| | | message |
| CPE ID | | ID of the CPE which receives the |
| | | mode change reply message |
| Flag | | Whether or not to apply the partial |
| | | FDD |
| | | 0: not apply |
| | | 1: apply |
| Number of Channels for TDD | | Number of TDD channels |
| For(i=1;i<=Number of Channel for | | |
| TDD;i++){ | | |
| | Channel Number for TDD[i] | TDD channel number |

}
For(Flag ==1){

| | |
|---|---|
| Number of Channels for FDD | Number of FDD channels |
| For(i=1;i<=Number of Channel | |

for FDD;i++){

| | |
|---|---|
| Channel number for FDD[i] | FDD channel number |
| } | |

}

In step 511, the CR base station determines whether the partial FDD scheme is applied. The CR base station verifies whether the CPE determined to apply the partial FDD scheme exists in step 507. When the partial FDD scheme is not applied, the CR base station returns to step 501.

When the partial FDD scheme is applied, the CR base station communicates in conformity with the partial FDD scheme in step 513. In other words, the CR base station communicates with some CPEs according to the TDD scheme and with other CPEs according to the partial FDD scheme.

FIG. 6 is a block diagram of a CPE in a CR wireless communication system according to an exemplary embodiment of the present invention.

Referring to FIG. 6, the CPE includes a Radio Frequency (RF) receiver 602, an OFDM demodulator 604, a subcarrier demapper 606, a symbol demodulator 608, a decoder 610, a message analyzer 612, a data buffer 614, a message generator 616, an encoder 618, a symbol modulator 620, a subcarrier mapper 622, an OFDM modulator 624, an RF transmitter 626, a spectrum sensor 628, and a controller 630.

The RF receiver 602 down-converts an RF band signal received via an antenna to a baseband signal. The OFDM demodulator 604 divides the baseband signal to OFDM symbols, removes a Cyclic Prefix (CP), and restores signals of a frequency band through Fast Fourier Transform (FFT) operation. The subcarrier demapper 606 classifies the signals of the frequency band based on a processing unit. The symbol demodulator 608 demodulates and converts the signals to a bit string. The decoder 610 decodes the bit string.

The message analyzer 612 obtains information contained in the message by analyzing the message received from the CR base station, and provides the obtained information to the controller 630. For instance, the message analyzer 612 analyzes the message, such as an FCH, a MAP, a DCD, and a UCD. More particularly, the message analyzer 612 confirms an application of a partial FDD scheme and information of a FDD channel by analyzing a mode change reply message for the partial FDD. For example, the mode change reply message is constituted as shown in Table 2. The message analyzer 612 confirms an ID of a PU interfered and information of an interfered channel by analyzing a beacon message received from the PU. The data buffer 614 temporarily stores data transmitted and received to and from the CR base station. The message generator 616 receives the information to transmit to the CR base station, from the controller 630, and generates a message including the information. More particularly, the message generator 616 generates the mode change request message to inform of reception of the beacon message. For example, the mode change request message is constituted as shown in Table 1.

The encoder 618 encodes the bit string of a CBP packet. The symbol modulator 620 modulates and converts the bit string to complex symbols. The subcarrier mapper 622 maps the complex symbols to a frequency domain. The OFDM modulator 624 converts the signals mapped to the frequency domain to a time-domain signal through Inverse FFT (IFFT) operation, and provides baseband OFDM symbols by inserting the CP. The RF transmitter 626 up-converts the baseband OFDM symbols to an RF signal and transmits the RF signal via the antenna.

The spectrum sensor 628 searches for the signal of the PU. More specifically, the spectrum sensor 628 scans the channel unused by the PU and the channel in which the signal of the PU is detected. The spectrum sensor 628 measures the signal strength from the PU. The spectrum sensor 628 provides the measured result to the controller 630.

The controller 630 controls the CPE functions. For example, the controller 630 controls the RF receiver 602 and the RF transmitter 626 to perform downlink communication and uplink communication over the band of an operating channel. The controller 630 controls the subcarrier demapper 606 to extract the signal from a resource allocated and confirmed from the MAP. When receiving the beacon message from the PU, the controller 630 confirms an ID of the PU transmitting the beacon message, a channel number interfering with the PU, and the signal strength from the PU. The controller 630 also controls the message generator 616 to generate the mode change request message. When receiving the mode change reply message from the CR base station, the controller 630 verifies from the information contained in the mode change reply message, whether the partial FDD scheme is applied, and operates according to the partial FDD scheme. Namely, when the partial FDD scheme is applied, the controller 630 controls the RF receiver 602 and the RF transmitter 626 to receive a downlink burst in the TDD channel and to transmit an uplink burst in the FDD channel.

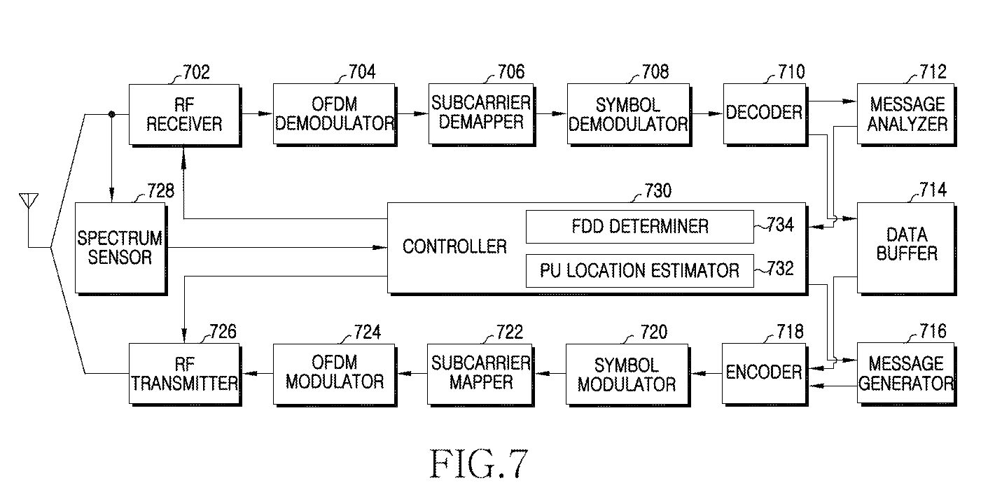

FIG. 7 is a block diagram of a CR base station in a CR wireless communication system according to an exemplary embodiment of the present invention.

Referring to FIG. 7, the CR base station includes an RF receiver 702, an OFDM demodulator 704, a subcarrier demapper 706, a symbol demodulator 708, a decoder 710, a message analyzer 712, a data buffer 714, a message generator 716, an encoder 718, a symbol modulator 720, a subcarrier mapper 722, an OFDM modulator 724, an RF transmitter 726, a spectrum sensor 728, and a controller 730.

The RF receiver 702 down-converts an RF band signal received via an antenna to a baseband signal. The OFDM demodulator 704 divides the baseband signal to OFDM symbols, removes a CP, and restores signals of a frequency band through an FFT operation. The subcarrier demapper 706 classifies the signals of the frequency band based on a processing unit. The symbol demodulator 708 demodulates and converts the signals to a bit string. The decoder 710 decodes the bit string.

The message analyzer 712 acquires information contained in the message by analyzing the message received from a CPE, and provides the acquired information to the controller 730. For instance, the message analyzer 712 analyzes the message, such as a bandwidth request and an UCS notification. More particularly, the message analyzer 712 confirms an ID of the CPE, the ID of a PU, an interfered channel, and signal strength from the PU by analyzing a mode change request message received from the CPE which receives a beacon message of the PU. For example, the mode change request message is constituted as shown in Table 1. The data buffer 714 temporarily stores data transmitted and received to and from the CPEs. The message generator 716 receives information to transmit to the CPEs, from the controller 730, and generates a message including the information. More particularly, the message generator 716 generates the message such as an FCH, a MAP, a DCD, and a UCD. The message generator 716 generates a mode change reply message indicating whether a partial FDD is applied, in response to the mode change request message. For example, the mode change reply message is constituted as shown in Table 2.

The encoder 718 encodes the bit string of a CBP packet. The symbol modulator 720 modulates and converts a bit string to complex symbols. The subcarrier mapper 722 maps the complex symbols to the frequency domain. The OFDM modulator 724 converts the signals mapped to the frequency domain to a time-domain signal through an IFFT operation, and provides baseband OFDM symbols by inserting the CP. The RF transmitter 726 up-converts the baseband OFDM symbols to an RF signal and transmits the RF signal via the antenna.

The spectrum sensor 728 searches for the signal of the PU. More specifically, the spectrum sensor 728 scans the channel not used by the PU and the channel in which the signal of the PU is detected. The spectrum sensor 728 measures the signal strength from the PU. The spectrum sensor 728 provides the measured result to the controller 730.

The controller 730 controls the functions of the CR base station. For example, the controller 730 determines operating channels of the CPEs by taking into account the channel use condition of the PU, and allocates the resources to the CPEs. The controller 730 controls the RF receiver 702 and the RF transmitter 726 to conduct a downlink communication and an uplink communication over the band of an operating channel. When receiving the mode change request message, the controller 730 functions to apply the partial FDD scheme. More specifically, a PU location estimator 732 of the controller 730 aggregates the signal strength information from the PU as contained in the mode change request message and estimates the location of the PU using the aggregated signal strength information. For example, the PU location estimator 732 may estimate the location of the PU through triangulation. Since the CPEs within a cell are not mobile, the PU location estimator 732 is aware of locations of the CPEs. An FDD determiner 734 of the controller 730 determines the CPE to apply the partial FDD scheme. Hence, at least one of the CPEs transmitting the mode change request message is determined to apply the partial FDD scheme, or it is determined not to apply the partial FDD scheme to any CPE. When the application of the partial FDD scheme is determined, the TDD channel and the FDD channel of the corresponding CPE are designated. Among the operating channels of the CPE, the channel interfering with the PU is designated as an uplink channel of the CPE and other channels are designated as a downlink channel. The controller 730 provides the message generator 716 with the information, such as application of the partial FDD scheme, TDD channel number, and FDD channel number. The controller 730 also controls the message generator 716 to generate the mode change reply message. Namely, when the partial FDD scheme is applied, the controller 730 controls the RF receiver 702 and the RF transmitter 726 to transmit and receive a downlink burst and an uplink burst in the TDD channel and to receive the uplink burst over the FDD channel.

In a CR wireless communication system, an unavailable channel for downlink communication because of an interfered PU is used as an uplink channel by taking into account a location of a CPE. Therefore, channel use efficiency and system performance may be improved.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An operating method of a Customer Premise Equipment (CPE) in a Cognitive Radio (CR) wireless communication system, the method comprising:
when receiving a beacon message from a Primary User (PU), transmitting a mode change request message comprising a signal strength from the PU and a channel number interfering with the PU to a base station;
when receiving a mode change reply message from the base station, determining whether a partial Frequency Division Duplex (FDD) scheme is applied; and
if it is determined that the partial FDD scheme is applied, communicating by receiving a downlink burst in a Time Division Duplex (TDD) channel indicated by the mode change reply message and transmitting an uplink burst in an FDD channel indicated by the mode change reply message.

2. The method of claim 1, further comprising:
if it is determined that the partial FDD scheme is not applied, communicating by receiving the downlink burst in the TDD channel indicated by the mode change reply message and transmitting the uplink burst in the TDD channel.

3. The method of claim 2, wherein the FDD channel comprises a channel interfering with the PU.

4. The method of claim 3, wherein the beacon message comprises at least one of an IDentifier (ID) of the PU and a channel number interfering with the PU.

5. The method of claim 3, wherein the mode change request message comprises at least one of an IDentifier (ID) of the CPE, an ID of the PU, a channel number interfering with the PU, and a signal strength from the PU.

6. The method of claim 3, wherein the mode change reply message comprises at least one of an IDentifier (ID) of the base station, an ID of the CPE, an application of the partial FDD scheme, a number of TDD channels, a TDD channel number, a number of FDD channels, and an FDD channel number.

7. An operating method of a base station in a Cognitive Radio (CR) wireless communication system, the method comprising:
when receiving a mode change request message from a Customer Premise Equipment (CPE), determining whether to apply a partial Frequency Division Duplex (FDD) scheme to the CPE;
transmitting a mode change reply message comprising whether the partial FDD scheme is applied, to the CPE; and
when applying the partial FDD scheme to the CPE, communicating with the CPE by transmitting a downlink burst in a Time Division Duplex (TDD) channel indicated by the mode change reply message and receiving an uplink burst in an FDD channel indicated by the mode change reply message.

8. The method of claim 7, further comprising:
when not applying the partial FDD scheme to the CPE, communicating with the CPE by transmitting a downlink burst in a TDD channel indicated by the mode change reply message and receiving an uplink burst in the TDD channel.

9. The method of claim 8, wherein the determining of whether to apply the partial FDD scheme comprises:
estimating a location of a Primary User (PU) comprising an IDentifier (ID) contained in the mode change request message; and
determining whether to apply the partial FDD scheme by taking into account the location of the PU and a location of the CPE.

10. The method of claim 9, wherein the FDD channel comprises a channel interfering with the PU.

11. The method of claim 10, wherein the beacon message comprises at least one of an ID of the PU and a channel number interfering with the PU.

12. The method of claim 10, wherein the mode change request message comprises at least one of an ID of the CPE, an ID of the PU, a channel number interfering with the PU, and a signal strength from the PU.

13. The method of claim 10, wherein the mode change reply message comprises at least one of an ID of the base station, an ID of the CPE, an application of the partial FDD scheme, a number of TDD channels, a TDD channel number, a number of FDD channels, and an FDD channel number.

14. An apparatus of a Customer Premise Equipment (CPE) in a Cognitive Radio (CR) wireless communication system, the apparatus comprising:
a transmitter for, when receiving a beacon message from a Primary User (PU), transmitting a mode change request message comprising a signal strength from the PU and a channel number interfering with the PU to a base station;
an analyzer for, when receiving a mode change reply message from the base station, determining whether a partial Frequency Division Duplex (FDD) scheme is applied; and
a controller for, when the partial FDD scheme is applied, communicating by receiving a downlink burst in a Time Division Duplex (TDD) channel indicated by the mode change reply message and for transmitting an uplink burst in an FDD channel indicated by the mode change reply message.

15. The apparatus of claim 14, wherein, when the partial FDD scheme is not applied, the controller communicates by receiving the downlink burst in the TDD channel indicated by the mode change reply message and transmitting the uplink burst in the TDD channel.

16. The apparatus of claim 15, wherein the FDD channel comprises a channel interfering with the PU.

17. The apparatus of claim 16, wherein the beacon message comprises at least one of an IDentifier (ID) of the PU and a channel number interfering with the PU.

18. The apparatus of claim 16, wherein the mode change request message comprises at least one of an IDentifier ID of the CPE, an ID of the PU, a channel number interfering with the PU, and a signal strength from the PU.

19. The apparatus of claim 16, wherein the mode change reply message comprises at least one of an IDentifier ID of the base station, an ID of the CPE, an application of the partial FDD scheme, a number of TDD channels, a TDD channel number, a number of FDD channels, and an FDD channel number.

20. An apparatus of a base station in a Cognitive Radio (CR) wireless communication system, the apparatus comprising:
a controller for, when receiving a mode change request message from a Customer Premise Equipment (CPE), determining whether to apply a partial Frequency Division Duplex (FDD) scheme to the CPE; and
a transmitter for transmitting a mode change reply message comprising whether the partial FDD scheme is applied, to the CPE,
wherein, when the partial FDD scheme is applied to the CPE, the controller communicates with the CPE by transmitting a downlink burst in a Time Division Duplex (TDD) channel indicated by the mode change reply message and receiving an uplink burst in an FDD channel indicated by the mode change reply message.

21. The apparatus of claim 20, wherein, when the partial FDD scheme is not applied to the CPE, the controller communicates with the CPE by transmitting a downlink burst in a TDD channel indicated by the mode change reply message and receiving an uplink burst in the TDD channel.

22. The apparatus of claim 21, wherein the controller comprises:
an estimator for estimating a location of a Primary User (PU) comprising an IDentifier (ID) contained in the mode change request message; and
a determiner for determining whether to apply the partial FDD scheme by taking into account the location of the PU and a location of the CPE.

23. The apparatus of claim 22, wherein the FDD channel comprises a channel interfering with the PU.

24. The apparatus of claim 23, wherein the beacon message comprises at least one of an ID of the PU and a channel number interfering with the PU.

25. The apparatus of claim 23, wherein the mode change request message comprises at least one of an ID of the CPE, an ID of the PU, a channel number interfering with the PU, and a signal strength from the PU.

26. The apparatus of claim 23, wherein the mode change reply message comprises at least one of an ID of the base station, an ID of the CPE, an application of the partial FDD scheme, a number of TDD channels, a TDD channel number, a number of FDD channels, and an FDD channel number.
